(19) United States
(12) Patent Application Publication
(10) Pub. No.: US 2024/0247020 A1
(43) Pub. Date: Jul. 25, 2024

(54) METAL COMPLEXES WITH SULFILIMINE-TYPE LIGANDS AND THEIR USE AS POLYMERIZATION

(71) Applicant: ARLANXEO NETHERLANDS B.V., RD Geleen (NL)

(72) Inventors: Alexandra BERTHOUD, Francheville (FR); Victor Fidel QUIROGA-NORAMBUENA, Lanaken (BE); Johannes Hendricus Wilhelmus VAN DE MOOSDIJK, NB Breda (NL)

(73) Assignee: ARLANXEO NETHERLANDS B.V., RD Geleen (NL)

(21) Appl. No.: 18/285,924

(22) PCT Filed: Apr. 8, 2022
(86) PCT No.: PCT/EP2022/059349

§ 371 Date: Oct. 6, 2023

(30) Foreign Application Priority Data
Apr. 9, 2021 (EP) 21167603.6

(51) Int. Cl. C07F 17/00; C08F 210/18

(52) U.S. Cl. CPC C07F 17/00; C08F 210/18

(57) ABSTRACT

A metal complex of general formula (I):

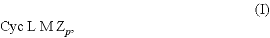

wherein
M is a metal selected from the group consisting of titanium, zirconium, and hafnium; Cyc is a cyclic ligand selected from cyclopentadienyl, indenyl, and fluorenyl and which may contain one or more substituents;
Z is an anionic ligand
L is a sulfilimine-containing ligand of general formula (II):

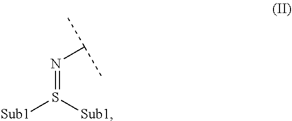

wherein Sub1 and Sub2 are aromatic residues which, independently from each other, may be unsubstituted or which may contain at least one substituent. Also provided is the use of the compound for polymerization of monomers and a process for producing polymers using the metal complex.

### BACKGROUND

The present disclosure relates to metal complexes comprising a metal of group 4 and having a sulfilimine-type containing ligand, the use of the metal complexes for the polymerization of olefins and to a process for producing polymers using the metal complex.

Polyolefins are polymers produced from simple alkenes such as alpha olefins or polyenes. They can be distinguished between thermoplastic polyolefins such as low-density polyethylene (LDPE), linear low-density polyethylene (LLDPE), very-low-density polyethylene (VLDPE), ultra-low-density polyethylene (ULDPE), medium-density polyethylene (MDPE), polypropylene (PP), polymethylpentene (PMP), and polybutene-1 (PB-1); and polyolefin elastomers (POE) such as high-density polyethylene (HDPE), ultra-high-molecular-weight polyethylene (UHMWPE), polyisobutylene (PIB), poly-alpha-olefin-ethylene-propylene rubber (EPM), and ethylene propylene diene monomer rubber (EPDM rubber). These polymers are generally produced using a polymerization catalyst. Many such catalysts are known. Half-metallocene catalysts with an amido group containing ligand and their use in the polymerization of olefins to produce polymers of high molecular weight are described, for example, in U.S. Pat. No. 6,114,481 and WO 2005/090418. However, there is still a need for alternative or improved polymerization catalysts.

It has now been found that half-metallocene metal complexes comprising a metal of group 4 and a sulfilimine-type ligand can be used in the polymerization of olefins to produce polyolefins, in particular olefins of high molecular weight, preferably of a molecular weight (Mw) of at least 200,000 g/mole.

### SUMMARY

In one aspect there is provided a metal complex of the general formula (I):

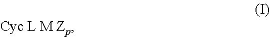

wherein
M is a metal selected from the group consisting of titanium, zirconium, and hafnium; Cyc is a cyclic ligand bonded to the metal M and is selected from unsubstituted and substituted cyclopentadienyls, indenyls, and fluorenyls;
Z is selected independently from neutral or anionic ligands bonded to the metal M, wherein the neutral ligands are selected from conjugated dienes having from 4 to 40 carbon atoms which, optionally, may be substituted once or more than once with a substituent selected from the group consisting of hydrocarbyl, silyl, halogenated carbyl and combinations thereof,
and wherein the anionic ligands are selected from the group consisting of the anionic forms of —H, —F, —Cl, —Br, —I, pseudohalogen, —C₁₋₁₂-alkyl, —O—C₁₋₁₂-alkyl, —C(═O)C₁₋₁₂-alkyl, —acetylacetonate, a biscarboxylate of a C₁₋₁₂ alkyl, -phenyl, —O-phenyl, —Si(C₁₋₁₂-alkyl)₃, —Ge(C₁₋₁₂-alkyl)₃, —N(C₁₋₁₂-alkyl)₂, —P(C₁₋₁₂)-alkyl)₂, —S—C₁₋₁₂-alkyl, and combinations thereof; preferably —C₁₋₁₂-alkyl, benzyl, —Si(CH₃)₃, —CH₂—Si(CH₃)₃, -phenyl, O-phenyl -phenyl and —O-phenyl substituted with 1, 2, 3, 4 or 5 substituents independently of one another selected from the group consisting of —C₁₋₁₂ alkyl, —O—C₁₋₁₂-alkyl, —N(C₁₋₁₂-alkyl)₂, —F, —Cl, —Br, —I, —pseudohalogen, and —Si(C₁₋₁₂-alkyl)₃,
index p is either 1 or 2, preferably 2; and
L is a sulfilimine-type ligand of the general formula (II):

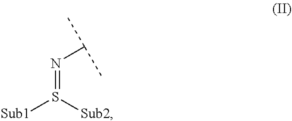

that is bonded by the nitrogen atom of the sulfur-nitrogen double bond to the metal M and wherein Sub1 and Sub2 are aromatic residues which, independently from each other, may be unsubstituted or which may contain at least one substituent.

In another aspect there is provided a process for preparing a polymer wherein the process comprises the steps
(a) providing a monomer composition comprising ethylene;
(b) contacting at least a fraction of the monomer composition with a catalyst composition comprising the metal complex to produce a polymer wherein the polymer comprises units derived from ethylene.

In a further aspect there is provided the use of a composition comprising the metal complex as polymerization catalyst for producing a polymer comprising units derived from ethylene.

### DETAILED DESCRIPTION

For a complete understanding of the present disclosure and the advantages thereof, reference is made to the following detailed description.

It should be appreciated that the various aspects and embodiments of the detailed description as disclosed herein are illustrative of the specific ways to make and use the disclosure and do not limit the scope of the disclosure when taken into consideration with the claims and the detailed description. It will also be appreciated that features from different aspects and embodiments of the disclosure may be combined with features from different aspects and embodiments of the disclosure.

In the following description the terms “containing”, “comprising,” “including,” “having,” and their derivatives, are not intended to exclude the presence of any additional component, step or procedure, whether or not the same is specifically disclosed.

In the following description norms may be used. If not indicated otherwise, the norms are used in the version that was in force on March 1, 2020. If no version was in force at that date because, for example, the norm has expired, the version is referred to that was in force at a date that is closest to March 1, 2020.

In the following description the amounts of ingredients of a composition or polymer may be indicated by “weight percent”, “wt. %” or “% by weight”. The terms “weight percent”, “wt. %” or “% by weight” are used interchangeably and are based on the total weight of the composition or polymer, respectively, which is 100% unless indicated otherwise.

The term “phr” means parts per hundred parts of rubber, i.e. the weight percentage based on the total amount of rubber which is set to 100%.

Ranges identified in this disclosure are meant to include and disclose all values between the endpoints of the range and the end points unless stated otherwise.

The term “substituted” is used to describe organic compounds where at least one hydrogen atom has been replaced by a chemical entity other than hydrogen. That chemical entity is referred to herein interchangeably as “substituent”, “residue” or “radical”. For example, the terms “a methyl group substituted by fluorine” or “a fluorine-substituted methyl group” refer to a fluorinated methyl group and include the groups —CF₃, —CHF₂ and —CH₂F. The term “unsubstituted” is meant to describe an organic compound or residue of which none of the hydrogen atoms has been replaced. For example, the term “unsubstituted methyl group” refers to methyl, i.e. —CH₃.

### Metal complexes

### Ligands Cyc

The ligands denoted “Cyc” are selected from cyclopentadienyl ligands, indenyl ligands and fluorenyl ligands. The Cyc-ligands may be unsubstituted, or they may be substituted, which means they contain one or more than one substituent.

Preferably, the substituents are selected independently of one another from the group consisting of C₁₋₁₂-alkyls, C₆-C₁₂ aryls, and trialkyl silanes. Examples of —C₁-C₁₂ alkyls include but are not limited to —CH₃, —CH₂CH₃, —CH₂CH₂CH₃, —CH(CH₃)₂, —C₄H₉ (including isomers), —C₆H₁₃ (including isomers), or —C₁₀H₂₁ (including isomers). Examples of C₆-C₁₂ aryls include but are not limited to phenyl, biphenyl (including isomers) and phenyls containing one or more alkyl substituent having from 1 to 6 carbon atoms.

In a preferred embodiment of the present disclosure the ligand Cyc is selected from cyclopentadienyl, methylcyclopentadienyl, dimethylcyclopentadienyl, trimethylcyclopentadienyl, tetramethylcyclopentadienyl and pentamethylcyclopentadienyl.

### Metal M

The metal M of the metal complex of the present disclosure in metal of group 4. For the purpose of this disclosure the term “metal of group 4” refers to conventional IUPAC nomenclature. Preferably, the metal M is selected from the group consisting of titanium, zirconium, and hafnium. In a particularly preferred embodiment of the invention, the metal M is titanium. The oxidation state of the metal M may be different depending on whether ligand Z is an anionic or a neutral ligand but the metal M is in an oxidation state such that the overall electrical charge of the metal complex is neutral.

### Ligand Z

In preferred embodiments, the ligand Z is anionic. Preferably, the ligand Z is selected from the group consisting of —H, —F, —Cl, —Br, —I, -pseudohalogen, —C₁₋₁₂-alkyl, —O—C₁₋₁₂-alkyl, —C(═O)C₁₋₁₂-alkyl, -acetylacetonate, a biscarboxylate of a C₁₋₁₂ alkyl, -phenyl, —O-phenyl, —Si(C₁₋₁₂-alkyl)₃, —Ge(C₁₋₁₂-alkyl)₃, —N(C₁₋₁₂-alkyl)₂, —P(C₁₋₁₂)-alkyl)₂, —S—C₁₋₁₂-alkyl, and combinations thereof; preferably —C₁₋₁₂-alkyl, wherein these ligands are in their anionic form. Pseudohalogens are polyatomic analogues of halogens, whose chemistry resembles that of the true halogens and allows them to substitute for halogens in several classes of chemical compounds. Suitable examples include, but are not limited to, —CN, —OCN, —SCN or —N₃.

Preferably, the ligand Z is selected from the group consisting of —CH₃, -benzyl, —Si(CH₃)₃, —CH₂—Si(CH₃)₃, -phenyl, -phenyl substituted with 1, 2, 3, 4 or 5 substituents independently of one another selected from the group consisting of —O—C₁₋₁₂-alkyl, —N(C₁₋₁₂-alkyl)₂, —F, and —Si(C₁₋₁₂-alkyl)₃ such as methoxyphenyl, dimethoxyphenyl, N,N-dimethylaminophenyl, bis(N,N-dimethylamino)phenyl, fluorophenyl, difluorophenyl, trifluorophenyl, tetrafluorophenyl, perfluorophenyl, trimethylsilylphenyl, bis(trimethylsilyl)phenyl, tris(trimethylsilyl)phenyl; preferably Z is —CH₃.

In another embodiment of the present disclosure the ligand Z is a neutral ligand and is selected from a conjugated diene. Diene ligands may be associated with the metal M in either an s-trans configuration (π-bound) or in an s-cis configuration (either π-bonded or σ-bonded). Preferably. the conjugated diene contains from 4 to 40 carbon atoms and, optionally, may be substituted once or more than once with substituents independently selected from the group consisting of hydrocarbyl, silyl, halogenated carbyl or a combination thereof. Examples of suitable neural ligands include, but are not limited to, butadiene, isoprene, 1,3-pentadiene, 1,4-diphenyl-1,3-butadiene; 2,3-diphenyl-1,3-butadiene; 3-methyl-1,3-pentadiene; 1,4-dibenzyl-1,3-butadiene; 2,4-hexadiene; 2,4,5,7-tetramethyl-3,5-octadiene; 2,2,7,7-tetramethyl-3,5-octadiene; 1,4-ditolyl-1,3-butadiene; 1,4-bis(trimethylsilyl)-1,3-butadiene; 2,3-dimethylbutadiene.

In a particularly preferred embodiment of the present disclosure, index p is 2 such that the metal complex comprises two ligands Z, and preferably both ligands Z are identical. In a particularly preferred embodiment of the disclosure the two ligands Z are each methyl anions.

In preferred embodiments of the metal complexes according to the present disclosure the index p is 1 and the complex corresponds to the general formula (I-A) or (I-B), or the index p is 2 and the metal complex according to the present disclosure corresponds to the general formula (I-C)

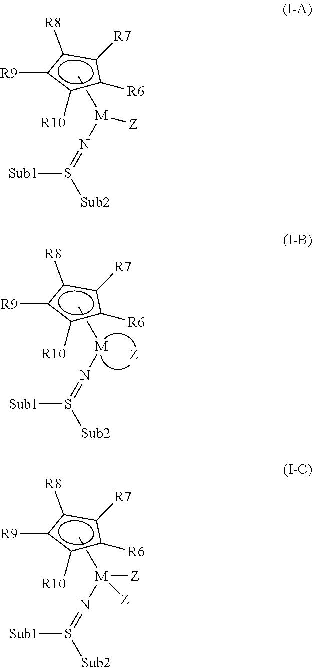

wherein in each case R6, R7, R8, R9 and R10 are selected, independently of one another, from the group consisting of —H, —CH₃, —CH₂CH₃, —CH₂CH₂CH₃, —CH(CH₃)₂, —C₄H₉ (including isomers), —C₆H₁₃ (including isomers), —C₁₀H₂₁ (including isomers), -phenyl, -biphenyl (including isomers), —Si(CH₃)₃, and mixtures thereof; preferably —CH₃. In the compound of general formula (I-B), the ligand Z is bidentate. The bidentate ligand Z may be monoanionic (e.g. acetylacetonate) or dianionic for example a biscarboxylate like oxalate). Preferably Z in formula (I-A) and (I-C) is selected from the group consisting of —CH₃, -benzyl, —Si(CH₃)₃, —CH₂—Si(CH₃)₃, -phenyl, -phenyl substituted with 1, 2, 3, 4 or 5 substituents independently of one another selected from the group consisting of —O—C₁₋₁₂-alkyl, —N(C₁₋₁₂-alkyl)₂, —F, and —Si(C₁₋₁₂-alkyl)₃ such as methoxyphenyl, dimethoxyphenyl, N,N-dimethylaminophenyl, bis(N,N-dimethylamino)phenyl, fluorophenyl, difluorophenyl, trifluorophenyl, tetrafluorophenyl, perfluorophenyl, trimethylsilylphenyl, bis(trimethylsilyl)phenyl, tris(trimethylsilyl)phenyl; more preferably Z is —CH₃.

Preferably, a metal complex of the present disclosure corresponds to the formula (I-C).

### Ligand L

Ligand L is a sulfilimine-type ligand and corresponds to the formula (II)

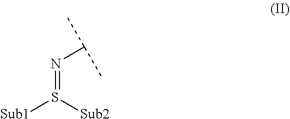

The sulfimine-type ligand is bonded via its N-atom to the metal M of the metal complex. The dotted line in formula (II) indicates that the metal M and the remainder of the metal complex are not shown in formula (II).

The substituents Sub1 and Sub2 of the sulfilimine-type ligand L may be the same or different. Preferably, each of the substituents Sub1 and Sub2 of the ligand L comprises an aryl residue. Preferably, the aryl residue is directly bonded to the sulfur atom of the ligand. However, it is also contemplated that the aryl residue is bridged to said sulfur atom through —C₁₋₆-alkylene-, —O—C₁₋₆-alkylene-, —C₁₋₆-alkylene-O—, or —O—; e.g. —CH₂—. Preferably, the aryl residue is selected from phenyl, —O-phenyl, pyridinyl, preferably phenyl, wherein the aryl residue may contain one or more substituents selected from C₁-C₄ alkyls and halogens, preferably F. Preferred embodiments of Sub1 and Sub2 include, independently from one another, phenyl, methyl phenyl, dimethyl phenyl, ethyl phenyl, isopropylphenyl, diisopropylephenyl, 2-pyridinyl, fluorophenyl and difluorophenyl.

In preferred embodiments of the metal complexes according to the present disclosure the ligand L corresponds to the general formula (III):

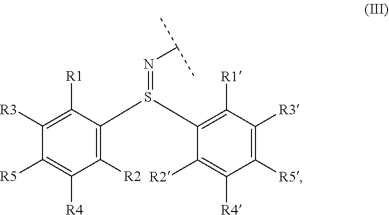

wherein R1, R2, R3, R4, R5, R1′, R2′, R3′, R4′, and R5′ independently of another are selected from the group consisting of —H, —F, —Cl, —Br, —I, —C₁₋₁₂-alkyl, —C₁₋₁₂-fluoroalkyl, —Si(C₁₋₁₂-alkyl)₃, -phenyl, —NH₂, —NH(C₁₋₁₂-alkyl), —N(C₁₋₁₂-alkyl)₂, —C(═O)—NH₂, —C(═O)—NH(C₁₋₁₂-alkyl), —C(═O)—N(C₁₋₁₂-alkyl)₂, —OH, —O—C₁₋₁₂-alkyl, —O—C₁₋₁₂-fluoroalkyl, —S—C₁₋₁₂-alkyl, —C(═O)C₁₋₁₂-alkyl, and combinations thereof; preferably —H, —F, —Cl, —Br, —I or —C₁₋₁₂-alkyl. Like in formula (II) the dotted line in formula (III) illustrates that the metal atom M and the remainder of the metal complex are not shown in formula (III).

In other preferred embodiments of the present disclosure R1, R2, R3, R4, R5, R1′, R2′, R3′, R4′, and R5′ are selected independently of another from —H, —F, —Cl, —Br, —I, —C₁₋₁₂-alkyl such as —CH₃, —CF₃, —CH₂CH₃, —CH₂CH₂CH₃, —CH(CH₃)₂, —C₄H₉ (including isomers), —C₆H₁₃ (including isomers), —C₁₀H₂₁ (including isomers); phenyl or biphenyl (including isomers), or —Si(C₁₋₁₂-alkyl)₃ such as —Si(CH₃)₃; and mixtures thereof. In one embodiment at least 2 or 3 of R1, R2, R3, R4, R5, R1′, R2′, R3′, R4′ and R5′ are selected from H. In one embodiment R1 and R2 represent H or CH₃; R1′ and R2′ represent H or F and R3, R4, R5, R3′, R4′, R5′ preferably represent H.

In a preferred embodiment of the present disclosure
R1, R2, R3, R4, R5, R1′, R2′, R3′, R4′, and R5′ represent H, methyl, ethyl, n-propyl, isopropyl, F, trifluoromethyl and combinations thereof wherein at least two of R1, R2, R3, R4 and R5 represent H and at least two of R1′, R2′, R3′, R4′ and R5′ represent H;
R1, R2, R3, R4, R5, R1′, R2′, R3′, R4′, and R5′ represent H, methyl, ethyl, n-propyl, isopropyl, F, trifluoromethyl and combinations thereof wherein at least three of R1, R2, R3, R4, and R5 represent H and at least three of R1′, R2′, R3′, R4′ and R5′ represent H;
R1, R2, R3, R4, R5, R1′, R2′, R3′, R4′, and R5′ represent H, methyl, ethyl, n-propyl, isopropyl, F, trifluoromethyl and combinations thereof wherein either all of R1, R2, R3, R4 and R5 represent H or all of R1′, R2′, R3′, R4′ and R5′ represent H.

In another preferred embodiments of the present disclosure
R1, R2, R3, R4, R5, R1′, R2′, R3′, R4′, and R5′ represent H;
R1 and R2 represent CH₃ and R3, R4, R5, R1′, R2′, R3′, R4′, and R5′ represent H; or
R1 and R2 represent CH₃, R1′ and R2′ represent F, and R3, R4, R5, R3′, R4′, and R5′ represent H.

Specific examples of ligands L include but are not limited to S,S-diphenylsulfilimine, S-2,6-dimethylphenyl-S-phenylsulfilimine and S-2,6-dimethylphenyl-S-2,6-difluorophenylsulfilimine, S-2,6-diisopropyl-S-phenylsulfilimine, S-2,6-dimethylphenyl-S-2,6-dimethylphenylsulfilimine. S-2,6-dimethyl-S-2-pyridinyl.

In preferred embodiments of the metal complex according to the present disclosure, index p is 1 and the metal complex corresponds to the general formula (I-D), or index p is 2 and the metal complex corresponds to general formula (I-E).

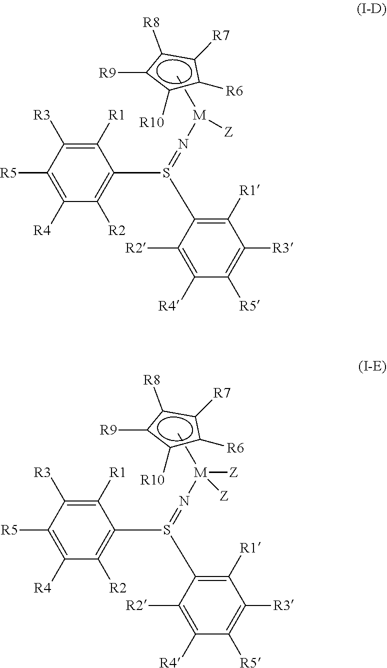

wherein in each case
the metal M is selected from the group consisting of titanium, zirconium, and hafnium; preferably titanium;
the ligand Z is selected from the group consisting of CH₃, benzyl, Si(CH₃)₃, CH₂—Si(CH₃)₃, phenyl, phenyl substituted with 1, 2, 3, 4 or 5 substituents independently of one another selected from the group consisting of O—C₁₋₁₂-alkyl, N(C₁₋₁₂-alkyl)₂, F, and Si(C₁₋₁₂-alkyl)₃ such as methoxyphenyl, dimethoxyphenyl, N,N-dimethylaminophenyl, bis (N,N-dimethylamino)phenyl, fluorophenyl, difluorophenyl, tri-fluorophenyl, tetrafluorophenyl, perfluorophenyl, trimethylsilylphenyl, bis(trimethylsilyl)phenyl, tris(trimethylsilyl)phenyl; preferably CH₃;
R1, R2, R3, R4, R5, R1′, R2′, R3′, R4′, and R5′ independently of another are selected from the group consisting of H, F, Cl, Br, I, CH₃, CH₂CH₃, CH₂CH₂CH₃, CH(CH₃)₂, C₄H₉ (including isomers), C₆H₁₃ (including isomers), C₁₀H₂₁ (including isomers), phenyl, biphenyl (including isomers), Si(CH₃)₃, and mixtures thereof; preferably H, CH₃ or F; and
R6, R7, R8, R9 and R10 independently of one another are selected from the group consisting of H, CH₃, CH₂CH₃, CH₂CH₂CH₃, CH(CH₃)₂, C₄H₉ (including isomers), C₆H₁₃ (including isomers), C₁₀H₂₁ (including isomers), phenyl, biphenyl (including isomers), Si(CH₃)₃, and mixtures thereof; preferably CH₃.

In a preferred embodiment of the present disclosure, index p is 2 and the metal complex corresponds to the general formula (I-E) and
M represents titanium;
Z represents methyl anions;
R1, R2, R1′ and R2′ represent —H, —CH₃ or —F and R3, R4, R5, R3′, R4′ and R5′ represent —H; and
R6, R7, R8, R9 and R10 represent —CH₃.

In another preferred embodiment of the present disclosure index p is 2 and the metal complex corresponds to the general formula (I-E) and
M represents titanium;
Z represents —CH₃;
R1, R2, R3, R4, R5, R1′, R2′, R3′, R4′ and R5′ represent H; and
R6, R7, R8, R9 and R10 represent —CH₃.

In another preferred embodiment of the present disclosure index p is 2 and the metal complex corresponds to the general formula (I-E) and
M represents titanium;
Z represents —CH₃;
R1 and R2 represent —CH₃ and R3, R4, R5, R1′, R2′ R3′, R4′ and R5′ represent —H; and
R6, R7, R8, R9 and R10 represent —CH₃.

In another preferred embodiment of the present disclosure index p is 2 and the metal complex corresponds to the general formula (I-E) and
M represents titanium;
Z represents —CH₃;
R1 and R2 represent —CH₃, R1′ and R2′ represent —F, and R3, R4, R5, R3′, R4′ and R5′ represent —H; and
R6, R7, R8, R9 and R10 represent —CH₃.

### Process for Preparing the Metal Complexes

Another aspect of the present disclosure relates to a process for the preparation of a metal complex of the general formula (I) as described above, comprising the steps of
(a) providing a reagent of general formula (IV)

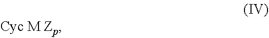

wherein
   M is a metal of group 4 as defined above;
   Cyc is a cyclic ligand as defined above; and
   Z is a ligand as defined above, preferably —CH₃, wherein index p is an integer 2 or 3, preferably 3;
(b) providing a sulfilimine-type ligand precursor according to general formula (V)

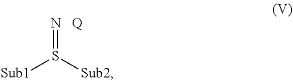

wherein
   Sub1 and Sub2 are defined as above; and
   Q is selected from the group consisting of H⁺, Li⁺, Na⁺, and K⁺; preferably H⁺;
(c) contacting the reagent of general formula (IV) provided in step (a) with the sulfilimine-type ligand precursor according to general formula (V) thereby obtaining the compound of general formula (I) and a byproduct Q-Z.

In preferred embodiments of the process according to the present disclosure, the sulfilimine-type ligand precursor of general formula (V) may be a sulfilimine as described above, in which case Q represents H⁺. In other preferred embodiments of the process according to the present disclosure the sulfilimine-type ligand precursor may be a metal salt of a sulfilimine as described above, wherein the sulfilimine is typically deprotonated and Q represents a metal atom; preferred metal atoms include, but are not limited to, Li⁺, Na⁺, and K⁺. In still other preferred embodiments of the process according to the present disclosure the sulfilimine-type ligand precursor may be an acid adduct of a sulfilimine as described above, in which case Q represents H⁺. In these embodiments, the sulfilimine is typically additionally protonated by an acid, giving it a positive charge and forming an adduct with the corresponding acid anion. Examples of suitable acid anions include, but are not limited to, F⁻, Cl⁻, Br⁻, I⁻, ClO₄²⁻, SO₄²⁻HSO₄⁻, PO₄³⁻, HPO₄²⁻, H₂PO₄⁻, CO₃²⁻, HCO₃⁻, aromatic or aliphatic carboxylates, BF4⁻, (substituted) tetraphenylborates, fluorinated tetraarylborates, —C₁₋₁₂-alkyl sulfonates and -aryl sulfonates.

Preferably, the sulfilimine-type ligand precursor is selected from a sulfilimine as defined above, a metal salt thereof, and an acid adduct thereof; preferably a sulfilimine. Preferably, the sulfilimine-type ligand precursor is an acid adduct of a sulfilimine as described above with an acid selected from the group consisting of HF, HCl, HBr, HI, HClO₄, H₂SO₄, HSO₄⁻, H₃PO₄, H₂PO₄⁻, HPO₄²⁻, H₂CO₃, HCO₃⁻, aromatic or aliphatic carboxylic acids, HBF₄, (substituted) tetraphenylboric acids, fluorinated tetraarylboric acids, —C₁₋₁₂-alkyl sulfonic acids and -aryl sulfonic acids. Preferably, the sulfilimine-type ligand precursor is a sulfilimine and step (c) comprises adding at least 1 equivalent of a base with respect to the reagent of formula (IV).

Preferably, the base is selected from the group consisting of amines, phosphanes, carboxylates, fluorides, hydroxides, cyanides, amides, organolithium compounds, and alkali metals.

In preferred embodiments of the process according to the present disclosure step (c) is performed in a solvent, which is selected from the group consisting of aromatic and aliphatic hydrocarbons, halogenated hydrocarbons, amides of the aliphatic carboxylic acids and primary or secondary amines, DMSO, nitromethane, acetone, acetonitrile, benzonitrile, ethers, polyethers, cyclic ethers, aromatic and aliphatic ethers, esters, pyridine, —C₁₋₁₂-alkylpyridines, cyclic and primary or secondary amines, and mixtures thereof; preferably aromatic hydrocarbons.

In another aspect of the present disclosure there is provided a compound of the general formula (I) above, which is obtainable by the process according to the present disclosure described above.

### Process of Producing Ethylene-Containing Polymers

Ethylene-containing polymers may be produced by using the metal complex according to the present disclosure. The metal complex may be used either alone or in combination with other polymerization catalysts or in combination with optional scavengers and activators or a combination thereof.

Therefore, in another aspect of the present disclosure there is provided a process for the preparation of a polymer comprising the steps of
(a) providing a monomer composition;
(b) polymerizing the monomer composition in the presence of a composition comprising the metal complex of the present disclosure to produce a polymer.

The process may further comprise, optionally, providing at least one scavenger and/or, optionally, providing at least one activator. The activator and scavenger may be a component of a catalyst composition comprising the metal complex of the present disclosure or they may be provided separately, for example as separate feed streams.

Polymers may be produced that have a broad or narrow molecular weight distribution (Mw/Mn). In one embodiment polymers may be produced that have a molecular weight distribution (Mw/Mn) from 1.80 to 30 or from 2 to 10.

Polymers may be produced that have a high or low Mooney viscosity. In one embodiment the polymer produced by the process has a Mooney viscosity ML 1+4 at 125° C. of at least 40 and up to a Mooney viscosity ML 1+8 at 150° C. of 100. In one embodiment of the present disclosure the polymer has a Mooney viscosity ML 1+4 at 125° C. of about 40 to about 100. In another embodiment of the present disclosure, the polymer has a Mooney viscosity ML 1+8 at 150° C. of from about 50 to about 100.

Polymers of high or low weight average molecular weight (Mw) may be produced by the process according to the present disclosure. In one embodiment the polymer has an (Mw) greater of at least 200,000 g/mole, for example from about 200.000 g/mole to about 600,000 g/mole.

Polymers with a high or low number average molecular weight (Mn) may be produced. In one embodiment the polymer produced by the process according to the present disclosure has an Mn of from 40,000 g/mole to 250,000 g/mole.

Branched or linear polymers may be produced with the process according to the present disclosure. The branching level of branched polymers may be high, moderate or low. The polymer branching level can be characterized by the parameter Δδ. Δδ, expressed in degrees, is the difference between the phase angle δ at a frequency of 0.1 rad/s and the phase angle δ at a frequency of 100 rad/s, as determined by Dynamic Mechanical Spectroscopy (DMS) at 125° C. and 10% strain. This quantity 48 is a measure for the amount of long chain branched structures present in the polymer and has been introduced in H. C. Booij, Kautschuk+Gummi Kunststoffe, Vol. 44, No. 2, pages 128-130, which is incorporated herein by reference. In one embodiment of the present disclosure polymers with a 48 of from 2 to 50 can be produced.

The polymers produced by the process according to the present disclosure may be monomodal, or they may be bimodal or multimodal. The polymers may have molecular weight distributions featuring two peaks or one peak and one shoulder in case of bimodal polymers or more than two peaks or two shoulders in case of multimodal polymers in a diagram obtained by gel permeation chromatography (GPC). Reactor blends may be produced also, which means polymers are produced in at least two different reaction vessels and are combined by blending. typically wet blending, i.e. by blending the reaction mixtures. Also block-polymers or grafted polymers may be produced.

### Ethylene-Containing Polymers:

The polymers that can be produced by using the metal complex according to the present disclosure contain units derived from ethylene and the monomer composition to be provided in the process according to the present disclosure contains at least ethylene. Preferably the polymer produced by the process according to the present disclosure is an ethylene-copolymer and more preferably an ethylene/alpha-olefin copolymer.

### Ethylene/Alpha-Olefin Polymers:

In one embodiment of the present disclosure the polymer produced with a metal complex according to the present disclosure is an ethylene/alpha-olefin-polymer. The ethylene/alpha-olefin-polymer is a copolymer of ethylene and another alpha-olefin and, optionally, one or more further comonomers. Ethylene/alpha-olefin polymers can be produced that comprise at least 20% by weight (based on the total weight of the polymer) of units derived from ethylene and may contain up to 80 percent by weight (wt. %) of units derived from ethylene. In one embodiment the ethylene-α-olefin-copolymer of the present disclosure comprises from 40 to 70 wt. %, preferably from 44 to 65 wt % of units derived from ethylene. The weight percentages are based on the total weight of the copolymer.

In addition to units derived from ethylene the polymer according to the present disclosure may contain units derived from one or more other alpha-olefins.

### Alpha-Olefins:

Alpha-olefins are olefins having a single aliphatic carbon-carbon double bond. The double bond is located at the terminal end (alpha-position) of the olefin. The a-olefins can be aromatic or aliphatic, linear, branched or cyclic. Typically, the alpha-olefins have from 3 to 20 carbon atoms.

Alpha-olefins include those represented by the formula: H₂C═X—CH₃.
where X represents an aliphatic alkylene residue having from 1 to 17 carbon atoms which may be linear or branched. Preferably the branches contain, independently from each other, from 1 to 3 carbon atoms.

In a preferred embodiment alpha-olefins include those represented by the formula: H₂C═CH—(CH₂)ₙ—CH₃ where n=represents 1, 2, 3, 4, 5, 6, 7, 8, 9, 10, 11, 12, 13, 14, 15, 16 and 17.

Preferred examples of alpha-olefins include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-hepta-decene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 9-methyl-1-decene, 11-methyl-1-dodecene and 12-ethyl-1-tetradecene.

One or more alpha-olefins may be used in combination. Preferably, the polymer contains at least 5 wt. % or at least 10 wt. % of units derived from one or more alpha-olefins. Polymers may be produced that contain up to 57 wt. %, more preferably up to 55 wt. % of units derived from one or more alpha-olefins (the weight percentages (wt. %) are based on the total weight of the polymer). Preferably, the ethylene-α-olefin-copolymer contains from 17 to 57 wt. % of total units derived from one or more alpha-olefin. Preferably, the polymer contains propylene.

### Non-Conjugated Dienes:

In addition to ethylene and alpha-olefin the ethylene/alpha-olefin polymers may be produced that additionally contain units derived from one or more non-conjugated diene as comonomer.

Non-conjugated dienes are polyenes comprising at least two carbon-carbon double bonds, the double bonds are non-conjugated and may be present in chains, rings, ring systems or combinations thereof. The carbon-carbon double bonds are separated by at least two carbon atoms. The polyenes may have endocyclic and/or exocyclic double bonds and may have no, the same or different substituents. Preferably, the non-conjugated dienes are aliphatic, more preferably aliphatic and alicyclic. Suitable non-conjugated dienes include, for example, aromatic polyenes, aliphatic polyenes and alicyclic polyenes, preferably polyenes with 6 to 30 carbon atoms (C₆-C₃₀-polyenes, more preferably C₆-C₃₀-dienes). Specific examples of non-conjugated dienes include but are not limited to 1,4-hexadiene, 3-methyl-1,4-hexadiene, 4-methyl-1,4-hexadiene, 5-methyl-1,4-hexadiene, 4-ethyl-1,4-hexadiene, 3,3-dimethyl-1,4-hexadiene, 5-methyl-1,4-heptadiene, 5-ethyl-1,4-heptadiene, 5-methyl-1,5-heptadiene, 6-methyl-1,5-heptadiene, 5-ethyl-1,5-heptadiene, 1,6-octadiene, 4-methyl-1,4-octadiene, 5-methyl-1,4-octadiene, 4-ethyl-1,4-octadiene, 5-ethyl-1,4-octadiene, 5-methyl-1,5-octadiene, 6-methyl-1,5-octadiene, 5-ethyl-1,5-octadiene, 6-ethyl-1,5-octadiene, 1,6-octadiene, 6-methyl-1,6-octadiene, 7-methyl-1,6-octadiene, 6-ethyl-1,6-octadiene, 6-propyl-1,6-octadiene, 6-butyl-1,6-octadiene, 4-methyl-1,4-nonadiene, 5-methyl-1,4-nonadiene, 4-ethyl-1,4-nonadiene, 5-ethyl-1,4-nonadiene, 5-methyl-1,5-nonadiene, 6-methyl-1,5-nonadiene, 5-ethyl-1,5-nonadiene, 6-ethyl-1,5-nonadiene, 6-methyl-1,6-nonadiene, 7-methyl-1,6-nonadiene, 6-ethyl-1,6-nonadiene, 7-ethyl-1,6-nonadiene, 7-methyl-1,7-nonadiene, 8-methyl-1,7-nonadiene, 7-ethyl-1,7-nonadiene, 5-methyl-1,4-decadiene, 5-ethyl-1,4-decadiene, 5-methyl-1,5-decadiene, 6-methyl-1,5-decadiene, 5-ethyl-1,5-decadiene, 6-ethyl-1,5-decadiene, 6-methyl-1,6-decadiene, 6-ethyl-1,6-decadiene, 7-methyl-1,6-decadiene, 7-ethyl-1,6-decadiene, 7-methyl-1,7-decadiene, 8-methyl-1,7-decadiene, 7-ethyl-1,7-decadiene, 8-ethyl-1,7-decadiene, 8-methyl-1,8-decadiene, 9-methyl-1,8-decadiene, 8-ethyl-1,8-decadiene, 1,5,9-decatriene, 6-methyl-1,6-undecadiene, 9-methyl-1,8-undecadiene, and mixtures thereof. Preferred non-conjugated dienes include alicyclic polyenes. Alicyclic dienes have at least one cyclic unit. In a preferred embodiment the non-conjugated dienes are selected from polyenes having at least one endocyclic double bond and optionally at least one exocyclic double bond. Preferred examples include dicyclopentadiene, 5-methylene-2-norbornene and 5-ethylidene-2-norbornene (ENB) with ENB being particularly preferred. In one embodiment the copolymer of the present disclosure contains only ENB as non-conjugated diene.

Further examples of non-conjugated dienes include dual polymerizable dienes. Dual polymerizable dienes include alpha-omega dienes, preferably linear alpha-omega dienes, vinyl substituted monocyclic and bicyclic non-conjugated dienes, which may be aliphatic or aromatic. The dual polymerizable dienes may cause or contribute to the formation of polymer branches. Examples of aliphatic dual polymerizable dienes include, but are not limited to, 1,4-divinylcyclohexane, 1,3-divinylcyclohexane, 1,3-divinylcyclopentane, 1,5-divinylcyclooctane, 1-allyl-4-vinylcyclo-hexane, 1,4-diallyl cyclohexane, 1-allyl-5-vinylcyclooctane, 1,5-diallylcyclooctane, 1-allyl-4-isopropenyl-cyclohexane, 1-isopropenyl-4-vinylcyclohexane and 1-isopropenyl-3-vinylcyclopentane, dicyclopentadiene (DCPD) and 1,4-cyclohexadiene. Preferred are non-conjugated vinyl norbornenes and C₈-C₁₂ alpha omega linear dienes (e.g., 1,7-octadiene, 1,8-nonadiene, 1,9-decadiene, 1,10-undecadiene, 1,11-dodecadiene). The dual polymerizable dienes may be further substituted with at least one group comprising a heteroatom of group 13-17 for example O, S, N, P, Cl, F, I, Br, or combinations thereof.

Examples of aromatic non-conjugated polyenes include vinylbenzene (including its isomers) and vinyl-isopropenylbenzene (including its isomers).

In a preferred embodiment of the present disclosure the dual polymerizable diene is selected from, dicyclopentadiene (DCPD), 5-vinyl-2-norbornene (VNB), 1,7-octadiene and 1,9-decadiene with 5-vinyl-2-norbornene (VNB) being most preferred.

In a typical embodiment of the present disclosure ethylene/alpha-olefin copolymers can be produced that contain at least 3 wt. % and up to and including 15 wt. % of units derived from the one or more non-conjugated diene.

In another embodiment of the present disclosure polymers are produced that contain non-conjugated dienes selected from, 5-ethylidene-2-norbornene (ENB), 5-vinyl-2-norbornene (VNB), 1,7-octadiene or 1,9-decadiene, dicyclopentadiene (DCPD) or a combination thereof. Preferably, the copolymer of the present disclosure contains from 0.05 wt. % to 5 wt. %, more preferably from 0.10 wt. % to 3 wt. % or from 0.15 wt. % to 1.2 wt. % of units derived from VNB (all weight percentages are based on the total weight of ethylene-α-olefin-copolymer). In another embodiment ethylene/α-olefin-copolymer can be produced that contains units derived from 5-ethylidene-2-norbornene and 5-vinyl-2-norbornene, for example the ethylene/alpha-olefin-copolymers produced may contain from 2 to 15 wt. % of units derived from ENB and from 0.05 to 4 wt. % of units derived from VNB.

The ethylene/α-olefin-copolymers can be produced by the process according to the present disclosure that may or may not contain units derived from other comonomers. The sum of units derived from ethylene, alpha-olefin and, optionally, non-conjugated diene may be greater than 90 wt. %, greater than 99 wt. % and including 100 wt. % based on the total weight of the ethylene/alpha-olefin polymer.

### Chain Transfer Agents:

The polymerization may include the use of one or more chain transfer agents to control the molecular weight of the polymer. A preferred chain transfer agent includes hydrogen (H₂). Other chain transfer agents include but are not limited to ethane, diethyl zinc and combinations thereof.

### Activators:

One or more activators, also referred to herein interchangeably as cocatalysts”, may be used in the polymerization. The cocatalysts are also referred to in the art as “activators”. The presence of cocatalysts typically increases the rate at which the catalyst polymerizes the olefins. The cocatalyst can also affect the molecular weight. degree of branching. comonomer content, or other properties of the polymer. The cocatalyst is typically introduced into the reactor separately from the catalyst or together with the catalyst, i.e. the metal complex.

Typical cocatalysts include but are not limited to boron containing activators. In a preferred embodiment the activators (b) are selected from boranes (C1) or borates (C2 or C3).

Suitable boron activators (C1) can be represented by the general formula BQ₁Q₂Q_{3.}

Suitable borate activator according to (C2) can be represented by the general formula G(BQ₁Q₂Q₃Q₄).

Suitable borate activators according to (C3) can be represented by the general formula (J-H)(BQ₁Q₂Q₃Q₄),

In the activator according to (C1) B is boron and Q₁ to Q₃ are substituted or unsubstituted aryl groups, preferably phenyl groups. Suitable substituents include but are not limited to halogens, preferably fluoride, and C₁ to C₄₀ hydrocarbyls, preferably C₁ to C₂₀ alkyls or aromatics. Specific examples of activators according to (C1) include tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, phenyl-bis(pentafluoro-phenyl)borane and the like.

In the activator according to (C2) G is an inorganic or organic cation, B is boron and Q₁ to Q₃ are the same as in (C1) and Q₄ is also a substituted or unsubstituted aryl group, preferably a substituted or unsubstituted phenyl. Substituents include but are not limited to halogens, preferably fluoride, and C₁ to C₄₀ hydrocarbyls, preferably C₁ to C₂₀ alkyls or aromatics. Specific examples for the borate group (BQ₁Q₂Q₃Q₄) include but are not limited to tetrakis(pentafluorophenyl)borate, tetrakis(2,3,5,6-tetrafluorophenyl)borate, tetrakis(3,4,5-trifluorophenyl)borate, tetrakis(2,3,4,5-tetrafluorophenyl)borate, teterakis(2,3,4-trifluorophenyl)borate, phenyltris(pentafluoro-phenyl) borate, tetrakis(3,5-bistrifluoromethylphenyl)borate and the like. Specific examples of G include a ferrocenium cation, an alkyl-substituted ferrocenium cation, silver cation and the like. Specific examples of an organic cation G include a triphenylmethyl cation and the like. G is preferably a carbenium cation, and particularly preferably a triphenylmethyl cation.

In the activator according to (C3) J represents a neutral Lewis base, (J-H) represents a Bronsted acid, B is a boron and both Q₁ to Q₄ and the borate group (BQ₁Q₂Q₃Q₄) are the same as in (C2). Specific examples of the Bronsted acid (J-H) include a trialkyl-substituted ammonium, N,N-dialkylanilinium, dialkylammonium, triaryl phosphonium and the like. Specific examples of activators according to (C3) include but are not limited to triethylammoniumtetrakis(pentafluoro-phenyl)-borate, tripropylammoniumtetrakis(pentafluorophenyl)borate, tri(n-butyl)ammonium-tetrakis(pentafluorophenyl)borate, tri(n-butyl)ammoniumtetrakis(3,5-bistrifluoromethyl-phenyl)borate, N,N-dimethyl-aniliniumtetrakis(pentafluoro-phenyl)borate, N,N-diethylaniliniumtetrakis(penta-fluorophenyl)borate, N,N-2,4,6-pentamethylanilinium-tetrakis(pentafluorophenyl)borate, N,N-dimethylanilinium-tetrakis(3,5-bistrifluoromethyl-phenyl)borate, diisopropyl-ammoniumtetrakis(penta-fluorophenyl)borate, dicyclohexyl-ammoniumtetrakis-(pentafluorophenyl)borate, triphenylphosphoniumtetrakis(penta-fluorophenyl)borate, tri(methylphenyl)phosphoniumtetrakis(pentafluorophenyl)borate, tri(dimethylphenyl)-phosphonium-tetrakis(pentafluorophenyl)borate and the like.

Other examples of cocatalysts include but are not limited to aluminium alkyls including trialkyl aluminium, trimethyl aluminium, triethyl aluminium, tri-isobutyl aluminium, or tri-n-octylaluminium. Other examples include but are not limited to alkyl aluminium halides including diethyl aluminium chloride, dimethyl aluminium chloride, ethyl aluminium sesquichloride. Further examples include but are not limited to alumoxanes and include methyl alumoxane (MAO), tetraisobutyl alumoxane (TIBAO) and hexaisobutyl alumoxane (HIBAO).

### Scavengers:

Impurities can harm catalysts by reducing their activity. Compounds that react with such impurities and turn them into harmless compounds for catalyst activity are referred to as scavengers by one skilled in the art of polymerization. Scavengers may be used in the process according to the present disclosure. Examples of scavengers include but are not limited to alkyl aluminum compounds, such as trimethyl aluminum, triethyl aluminum, tri-isobutyl aluminum, and trioctyl aluminum. The scavenger may also act as a cocatalyst. In this case the scavenger is generally applied in excess of what is needed to fully activate the catalyst.

In an embodiments of the process according to the invention, the molar ratio of activator provided in step (c) of the process to the metal complex according to the present disclosure is from 10:1 to 1:1, preferably from 2:1, preferably 1:2.

The scavenger, preferably an aluminium-containing scavenger can used in combination with a sterically hindered hydrocarbon or a sterically hindered heterohydrocarbon, preferably a sterically hindered phenol, containing a group 15 or 16 heteroatom, (preferably O, N, P and S atoms, more preferably O and N heteroatoms). Specific examples of sterically hindered hydrocarbons include but are not limited to tert-butanol, iso-propanol, triphenylcarbinol, 2,6-di-tert-butylphenol, 4-methyl-2,6-di-tert-butylphenol, 4-ethyl-2,6-di-tert-butylphenol, 2,6-di-tert-butylanilin, 4-methyl-2,6-di-tert-butylanilin, 4-ethyl-2,6-di-tert-butylanilin, diisopropylamine, di-tert-butylamine, diphenylamine and the like. A preferred sterically hindered compound is 4-methyl-2,6-tertbutyl phenol.

In the process of producing polymers according to the present disclosure the monomer composition is contacted with at least one metal complex according to the present disclosure. Contacting may take place in the gas phase. It may also take place in the presence of one or more solvents, for example in solution or in a slurry. The polymerization may be carried out in solution or slurry under sufficient pressure and temperatures such that no gas phase is formed. Preferably, the polymerization is carried out as solution or slurry polymerization. Preferred solvents include one or more hydrocarbon solvent. Suitable solvents include C₅₋₁₂ hydrocarbons such as pentane, hexane, heptane, octane, cyclohexane, methylcyclohexane, pentamethyl heptane, hydrogenated naphtha, isomers and mixtures thereof.

The process can be carried at reaction temperatures and pressures as known in the art for the polymerization of such polymers. In a preferred embodiment of the present disclosure the metal complexes according to the present disclosure have catalytic polymerization activity at temperatures as high as 130° C. and pressures of at least 8.3 bar.

In another aspect of the present disclosure there is provided o a polymer obtainable by the process according to the invention as described above. In one embodiment the polymer is ethylene propylene rubber (EPM) or ethylene propylene diene monomer rubber (EPDM).

### Other Aspects of the Disclosure

Another aspect of the invention relates to a use of a metal complex according to the present disclosure as polymerization catalyst for polymerizing a monomer composition as defined above.

In another aspect of the present disclosure there is provided a supported catalyst, which comprises the metal complex according to the present disclosure, on a supporting material. The supported catalyst may optionally further contain a scavenger or an activator or a combination of scavenger and activator. The supporting material may be a solid material with a high surface area, to which at least one metal complex of the present disclosure is affixed. Typically, the activity of heterogeneous catalysts occurs at the surface atoms. Consequently, great effort is made to maximize the surface area of a catalyst. One suitable method for increasing surface area involves distributing the catalyst over the supporting material. The supporting material may be inert or participate in the catalytic reactions. Preferably, the supporting material is selected from the group consisting of silica, magnesium halogenides, such as MgF₂, MgCl₂, MgBr₂, MgI₂, zeolites, alumina, polystyrene, polypropylene, polyethylene, polyamides, polyesters and combinations thereof.

### EXAMPLES

The following examples further illustrate the present disclosure without any intention to limit the disclosure to these examples.

### General Operation Procedures

All experiments for preparing the half-metallocene compounds were carried out using standard Schlenk line or dry-box techniques under an atmosphere of argon or nitrogen. Solvents were degassed by sparging with nitrogen and dried by passing through a column of the appropriate drying agent.

Deuterated solvents were dried over CaH₂, distilled under reduced pressure and stored under nitrogen in PTFE valve ampoules. NMR samples were prepared under nitrogen in 5 mm 507-PP tubes from SP Wilmad-LabGlass fitted with J. Young PTFE valves. ¹H, ¹⁹F and ¹³C-{¹H} spectra were recorded at ambient temperature and referenced internally to residual protic-solvent (¹H) or solvent (¹³C) resonances and are reported relative to tetramethylsilane (d=0 ppm). Chemical shifts are quoted in δ (ppm) and coupling constants in Hz. NMR spectra were measured on a Avance 400 spectrometer from Bruker.

Fourier transformation infrared spectroscopy (FT-IR), was used to determine the composition of the copolymers according to the method that is known in the art. The FT-IR measurement gives the composition of the various monomers in weight percent relative to the total composition. Composition was determined using mid-range FT-IR spectroscopy.

### Synthesis of Catalysts:

Different half-metallocene metal complex catalysts (compounds 1-3, “cpds 1-3”) were prepared with different sulfilimine-type ligands as follows:

### (Pentamethylcyclopentadienyl)[S,S-diphenylsulfide]titanamine dimethyl (Cpd 1)

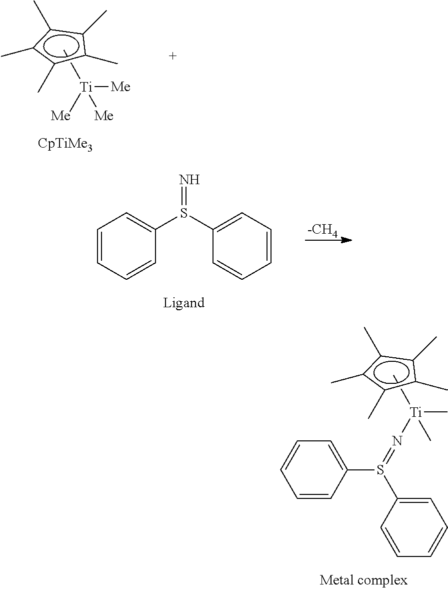

S,S-diphenylsulfilimine (30.0 mg, 149.0 μmol) and Cp*TiMe₃ (34.0 mg, 149.0 μmol) were dissolved in C₆D₆ (1 mL) and submitted for ¹H NMR. Full conversion to the desired product was observed.

¹H NMR (300 MHZ, C₆D₆) δ 7.90-7.77 (m, 4H, meta-ArH), 7.08-6.94 (m, 4H, ortho-ArH), 6.93-6.83 (m, 2H, para-ArH), 1.97 (s, 15H, CpCH₃), 0.69 (s, 6H, TiCH₃). For the polymerization reactions a solution of 5.0 mg (25 μmol) of the ligand in 1 ml toluene was added to a solution of CpTiMe₃ (5.7 mg, 25 μmol) in 1 ml of toluene. The resulting solution was diluted with toluene to a total volume of 25 mL and was used in the batch reactor.

### (Pentamethylcyclopentadienyl)[S-2,6-dimethylphenyl-S-phenylsulfide]titanamine dimethyl (Cpd 2)

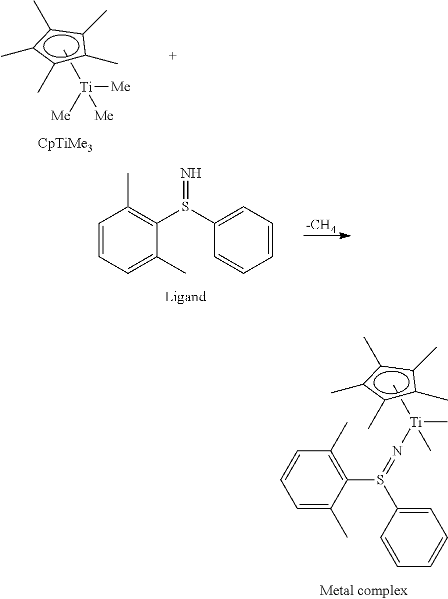

S-2,6-dimethylphenyl-S-phenylsulfilimine (10.0 mg, 43.6 μmol) and Cp*TiMe₃ (10.0 mg, 43.6 μmol) were dissolved in C₆D₆ (1 mL) and submitted for ¹H NMR. Full conversion to the desired product was observed.

¹H NMR (300 MHZ, C₆D₆) δ 7.82-7.74 (m, 2H, meta-ArH), 7.04 (tt, J=6.9, 0.9 Hz, 2H, ortho-ArH), 6.98-6.90 (m, 1H, para-ArH), 6.89-6.80 (m, 1H, para-ArMe2H), 6.70 (dq, J=7.5, 0.7 Hz, 2H, meta-ArMe2H), 2.54 (s, 6H, CH₃), 1.97 (s, 15H, CpCH₃), 0.67 (d, J=0.8 Hz, 3H, TiCH₃), 0.54 (d, J=0.8 Hz, 3H, TiCH₃).

For the polymerization reactions a solution of 5.7 mg (25 μmol) of the ligand in 1 ml toluene was added to a solution of CpTiMe₃ (5.7 mg, 25 μmol) in 1 ml of toluene. The resulting solution was diluted with toluene to a total volume of 25 mL and was used in the batch reactor.

### (Pentamethylcyclopentadienyl)[S-2,6-dimethylphenyl-S-2,6-difluorophenylsulfide]titanamine dimethyl (Cpd 3)

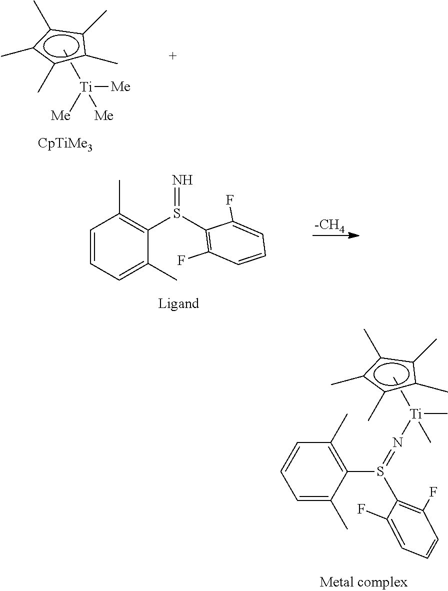

S-2,6-dimethylphenyl-S-2,6-difluorophenylsulfilimine (6.6 mg, 25 μmol) and Cp*TiMe₃ (5.7 mg, 25 μmol) were dissolved in C₆D₆ and submitted for ¹H and ¹⁹F NMR. Full conversion to the desired product was observed.

¹H NMR (300 MHZ, C₆D₆): δ 6.89-6.82 (m, 1H, para-ArMe2H), 6.74 (dtd, J=7.2, 1.2, 0.6 Hz, 2H, meta-ArMe2H), 6.46-6.35 (m, 1H, para-ArF2H), 6.30-6.20 (m, 2H, meta-ArF2H), 2.83 (d, J=0.8 Hz, 6H, ArCH₃), 1.97 (s, 15H, CpCH₃), 0.54 (d, J=0.6 Hz, 3H, TiCH₃), 0.51 (q, J=0.6 Hz, 3H, TiCH₃). ¹⁹F NMR (282 MHZ, C₆D₆): δ−110.93.

For the polymerization reactions a solution of 6.6 mg (25 mmol) of the ligand in 1 ml toluene was added to a solution of CpTiMe₃ (5.7 mg, 25 μmol) in 1 ml of toluene. The resulting solution containing the half-metallocene complex was diluted with toluene to a total volume of 25 mL and was used in the batch reactor.

Lab scale amounts of sulfilimine-type ligands with substituted aryl residues were prepared by reacting diaryl sulfide precursors with mesitylsulfonylhydroxylamine and treatment with anion exchange resin (AMBERLITE IRA-402 ion exchange resin in OH-form, ethanol as eluent). Since mesitylsulfonylhydroxylamine is prone to self-decomposition and has to be care handled with great it was prepared in situ (prepared from O-mesitylsulfonylhydroxylamine, in dimethylformamide in the presence of triethyleamine at 0° C.). The diaryl sulfide precursors were prepared as reported by Cheng et al (Journal of Organic Chemistry 2012, 77, 10369) and Clayden et al (Angew. Chem. Int. Ed. 2009, 48, 6270).

An unsubstituted diarylsulfilimine ligand was prepared by stirring S,S-diphenylsulfilimine monohydride (500 mg, 2.28 mmol) in toluene (30 mL) over CaH₂ (1 g). S,S-diphenylsulfilimine monohydride is commercially available, for example from Sigma-Aldrich. The reaction mixture was filtered and the residue was washed with toluene (3×5 mL) and dried in vacuo.

### Polymerizations:

### Polymer Composition:

Fourier transformation infrared spectroscopy (FT-IR) can be used to determine the composition of the copolymers according to ASTM D3900 (revision date 2017) for the C2/C3 ratio and D6047 (revision date 2017) for the diene content on pressed polymer films.

### Phase Angle Measurements:

The polymer branching can be determined by phase angle measurements on a Montech MDR 3000 moving die rheometer with parameter Δδ. Δδ (expressed in degrees) is the difference between the phase angle δ measured at a frequency of 0.1 rad/s and the phase angle δ measured at a frequency of 100 rad/s determined by Dynamic Mechanical Analysis (DMA) at 125° C. Δδ is a measure for the presence of long-chain branches in the polymer structure and has been introduced by H. C. Booij, in Kautschuk+Gummi Kunststoffe, Vol. 44, No. 2, pages 128-130, 1991, which is incorporated herein by reference. The lower the value of Δδ the more long-chain branches are present in the polymer.

### Molecular Weights:

The molecular weights (Mw, Mn, Mz) and the molecular weight distribution (MWD) can be determined by gel permeation size exclusion chromatography (GPC) using a Polymer Char GPC-IR from Polymer Characterization S.A, Valencia, Spain. The Size Exclusion Chromatograph is equipped with an online viscometer (Polymer CharV-400 viscometer), an online infrared detector (IR5 MCT), with 3 AGILENT PL OLEXIS columns (7.5×300 mm) and a Polymer Char autosampler. Universal calibration of the system is performed with polyethylene (PE) standards.

The polymer samples are weighed (in the concentration range of 0.3-1.3 mg/ml) into the vials of the PolymerChar autosampler. In the autosampler the vials are filled automatically with solvent (1,2,4-tri-chlorobenzene stabilized with 1 g/l di-tertbutylparacresol (DBPC)). The samples are kept in the high temperature oven (160° C.) for 4 hrs. After this dissolution time, the samples are automatically filtered by an in-line filter before being injected onto the columns. The chromatograph system is operated at 160° C. The flow rate of the 1,2,4-trichlorobenzene eluent is 1.0 mL/min.

### Mooney Viscosity:

The Mooney viscosity of the copolymer samples can be measured according to ISO 289, revision date 2015, with biaxially strained PP (20 μm thickness) film, provided by Perfon B. V., Goor, The Netherlands. The measuring conditions are typically ML (1+4) @ 125° C.

### Example 1 (EPM Polymers)

Batch co-polymerizations were carried out in a 2-liter batch autoclave equipped with a double impeller and baffles. The reaction temperature was controlled by a LAUDA Thermostat. The feed streams (solvents and monomers) were purified by contacting with various adsorption media to remove catalyst killing impurities such as water, oxygen and polar compounds as is known to those skilled in the art. During polymerization the ethylene and propylene monomers were continuously fed to the gas cap of the reactor. The pressure of the reactor was kept constant by a backpressure valve.

In an inert atmosphere of nitrogen, the reactor was filled with pentamethylheptane (PMH) (950 mL), triisobutylaluminum (TiBA), 2,6-di-tert-butyl-4-methylphenol (BHT), The reactor was heated to the desired temperature while stirring at 1350 rpm. The reactor was pressurized and conditioned under a determined ratio of ethylene and propylene. After 10 minutes, the catalyst component and the borate co-catalyst when applicable were added into the reactor (0.02-0.14 μmol depending on catalyst productivity) and the catalyst vessel was rinsed with PMH (50 mL) subsequently. After 10 minutes of polymerization, the monomer flow was stopped and the solution was carefully dumped in an Erlenmeyer flask of 2 L, containing a solution of IRGANOX-1076 in iso-propanol and dried over night at 100° C. under reduced pressure. The polymers were analyzed for molecular-weights (SEC-IR) 5 and composition (FT-IR).
Examples 1a to 1d were carried out with Cpd 1 as catalyst.
Examples 1e to 1h were carried out with Cpd. 2 as catalyst.
Examples 1i to 1l were carried out with Cpd. 3 as catalyst.

EPM Polymers with a high weight average molecular weight (Mw) were obtained. The results and polymerization details are summarized in table 1.

TABLE 1
Results of examples 1a) to 1l)

| | | Cat | | | | | | | | |
|---|---|---|---|---|---|---|---|---|---|---|
| | | dosing | ΔT | Yield | Productivity | | C2 | C3 | | |
| No | Setting | μmol | ° C. | G | ppmTi | Activity** | wt. % | wt. % | Mn* | Mw* |
| 1a | EPM 80 C. | 0.10 | 3.8 | 7.0 | 0.7 | 277 | 55 | 45 | 503 | 1388 |
| 1b | EPM 100 C. | 0.10 | 3.4 | 7.8 | 0.6 | 223 | 53 | 47 | 315 | 810 |
| 1c | EPM 120 C. | 0.10 | 1.2 | 4.8 | 1.0 | 107 | 54 | 46 | 200 | 579 |
| 1d | EPM 130 C. | 0.10 | 0.9 | 1.9 | 2.5 | 38 | 55 | 45 | 224 | 506 |
| 1e | EPM 80 C. | 0.04 | 4.8 | 15.5 | 0.1 | 1540 | 54 | 47 | 404 | 880 |
| 1f | EPM 100 C. | 0.04 | 3.9 | 12.1 | 0.2 | 868 | 51 | 49 | 243 | 541 |
| 1g | EPM 120 C. | 0.04 | 1.3 | 4.2 | 0.5 | 239 | 56 | 44 | 189 | 405 |
| 1h | EPM 130 C. | 0.10 | 1.0 | 3.5 | 1.4 | 71 | 57 | 43 | 137 | 304 |
| 1i | EPM 80 C. | 0.03 | 4.2 | 16.0 | 0.1 | 2114 | 50 | 50 | 446 | 898 |
| 1j | EPM 100 C. | 0.03 | 2.6 | 10.5 | 0.1 | 1004 | 47 | 53 | 300 | 611 |
| 1k | EPM 120 C. | 0.03 | 0.8 | 3.1 | 0.5 | 234 | 51 | 49 | 212 | 457 |
| 1l | EPM 130 C. | 0.10 | 2.1 | 5.2 | 0.9 | 105 | 52 | 48 | 125 | 299 |

*in kg/mole;
**kg · mol_{Ti}⁻¹ · h⁻¹bar⁻¹
Reaction conditions:
EPM 80 C. = 80° C., 4.2 bar, 10 min, [BHT] = 900 μmol/L, [Al] = 450 μmol/L, [B] = 2 * [Ti], C3: 400 NL/h, C2: 290 NL/h;
EPM 100 C. = 100° C., 5.8 bar, 10 min, [BHT] = 900 μmol/L, [Al] = 450 μmol/L, [B] = 2*[Ti], C3: 400 NL/h, C2: 190 NL/h;
EPM 120 C. = 120° C., 7.4 bar, 10 min, [BHT] = 900 μmol/L, [Al] = 450 μmol/L, [B] = 2*[Ti], C3: 400 NL/h, C2: 172 NL/h;
EPM 130 C. = 130° C., 8.3 bar, 10 min, [BHT] = 900 μmol/L, [Al] = 450 μmol/L, [B] = 2*[Ti], C3: 400 NL/h, C2: 159 NL/h.

### Example 2 (EPDM Polymers)

### General Procedure:

The procedure for EPM polymerization in example 1 was followed except that the reactor was filled in an inert atmosphere with pentamethylheptane (PMH) (950 mL), triisobutylaluminum (TiBA), 2,6-di-tert-butyl-4-methylphenol (BHT), 5-ethylidene-2-norbonene (ENB), and 5-vinyl-2-norbornene (VNB). Additionally, hydrogen (0.35 NL/h) was dosed to the pressurized reactor.
Example 2.1 was carried out with Cpd 1.
Example 2.2 was carried out with Cpd 2.
Example 2.3 was carried out with Cpd 3.

EPDM Polymers with high weight average molecular weight (Mw) of greater than 200,000 g/mole were obtained. The results and polymerization details are summarized in table 2.

TABLE 2
Results of Example 2

| | Cat dosing | ΔT | Yield | Productivity | | C2 | C3 | ENB | VNB | |
|---|---|---|---|---|---|---|---|---|---|---|
| No | μmol | ° C. | G | ppm Ti | Activity** | wt. % | wt. % | wt. % | wt. % | Mw* |
| 2.1 | 0.10 | 3.0 | 4.8 | 1.00 | 115 | 50 | 47 | 1.7 | 1.0 | 593 |
| 2.2 | 0.10 | 3.8 | 10.4 | 0.46 | 247 | 47 | 51 | 1.2 | 0.7 | 431 |
| 2.3 | 0.10 | 2.1 | 5.0 | 0.97 | 118 | 48 | 50 | 1.6 | 1.2 | 687 |

*kg/mol;
**kg · mol_{Ti}^{-1 ·} h^{-1 ·} bar⁻¹
Reaction conditions:
90° C., 7 bar, 10 min, [BHT] = 900 μmol/L, [Al] = 450 μmol/L, [B] = 2*[Ti], C3: 400 NL/h; C2: 200 NL/h; H₂: 0.35 NL/h; 0.7 mL ENB, 0.7 mL VNB

1. A metal complex of the general formula (I): 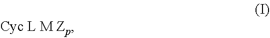
wherein
M is a metal selected from the group consisting of titanium, zirconium, and hafnium; Cyc is a cyclic ligand selected from cyclopentadienyl, indenyl, and fluorenyl, each of which optionally contains one or more substituents;
Z is selected independently from neutral or anionic ligands bonded to the metal M, wherein the neutral ligands are selected from conjugated dienes having from 4 to 40 carbon atoms which, optionally, may be substituted once or more than once with a substituent selected from the group consisting of hydrocarbyl, silyl, halogenated carbyl. and combinations thereof, and wherein the anionic ligands are ligands are selected from the group consisting of the anionic forms of —H, —F, —Cl, —Br, I, -pseudohalogen, —C₁₋₁₂-alkyl, —O—C₁₋₁₂-alkyl, —C(═O)C₁₋₁₂-alkyl, -acetylacetonate, a biscarboxylate of a C₁₋₁₂ alkyl, -phenyl, —O-phenyl, —Si(C₁₋₁₂-alkyl)₃, —Ge(C₁₋₁₂-alkyl)₃, —N(C₁₋₁₂-alkyl)₂, —P(C₁₋₁₂)-alkyl)₂, —S—C₁₋₁₂-alkyl, and combinations thereof; preferably —C₁₋₁₂-alkyl, -benzyl, —Si(CH₃)₃, —CH₂—Si(CH₃)₃, -phenyl, O-phenyl -phenyl and —O-phenyl substituted with 1, 2, 3, 4 or 5 substituents independently of one another selected from the group consisting of —C₁₋₁₂ alkyl, —O—C₁₋₁₂-alkyl, —N(C₁₋₁₂-alkyl)₂, —F, —Cl, —Br, —I, -pseudohalogen, and —Si(C₁₋₁₂-alkyl)₃, index p is either 1 or 2; and
L is a sulfilimine-type ligand of general formula (II): 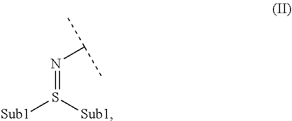
wherein Sub1 and Sub2 are aromatic residues which, independently from each other, may be unsubstituted or which may contain at least one substituent.

2. The metal complex according to claim 1, wherein the ligand L corresponds to the general formula (III): 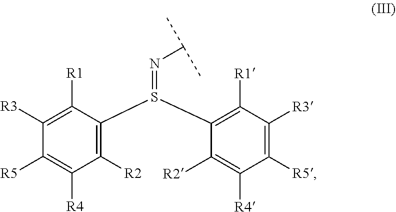
wherein R1, R2, R3, R4, R5, R1′, R2′, R3′, R4′, and R5′ are selected independently of another from the group consisting of H, F, Cl, Br, I, —C₁₋₁₂-alkyl, —C₁₋₁₂-fluoroalkyl, —Si(C₁₋₁₂-alkyl)₃, -phenyl, —NH₂, —NH(C₁₋₁₂-alkyl), —N(C₁₋₁₂-alkyl)₂, —C(═O)—NH₂, —C(═O)—NH(C₁₋₁₂-alkyl), —C(═O)—N(C₁₋₁₂-alkyl)₂, —OH, —O—C₁₋₁₂-alkyl, —O—C₁₋₁₂-fluoroalkyl, —S—C₁₋₁₂-alkyl and —C(═O)C₁₋₁₂-alkyl.

3. The metal complex according to claim 1, wherein the ligand L corresponds to the general formula (III) 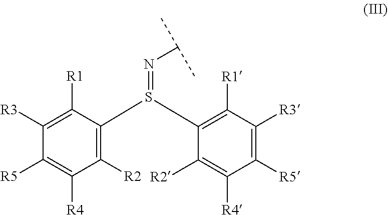
and wherein R1, R2, R3, R4, R5, R1′, R2′, R3′, R4′, and R5′ are selected independently of another from —H, —F, —Cl, —Br, —I, —CF₃, —CH₃, —CH₂CH₃, —CH₂CH₂CH₃, —CH(CH₃)₂, —C₄H₉, —C₆H₁₃, —C₁₀H₂₁; phenyl, and —Si(CH₃)₃ and wherein at least 2 or at least 3 of R1, R2, R3, R4, R5, R1′, R2′, R3′, R4′ and R5′ are selected from —H.

4. The metal complex according to claim 1, wherein the ligand L corresponds to the general formula (III) 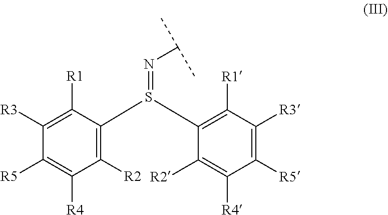
and wherein
R1, R2, R3, R4, R5, R1′, R2′, R3′, R4′, and R5′ represent residues selected from hydrogen, methyl, ethyl, n-propyl, isopropyl, fluorine, trifluoromethyl, and combinations thereof wherein at least two of R1, R2, R3, R4 and R5 represent H and at least two of R1′, R2′, R3′, R4′ and R5′ represent hydrogen;
R1, R2, R3, R4, R5, R1′, R2′, R3′, R4′, and R5′ represent residues selected from hydrogen, methyl, ethyl, n-propyl, isopropyl, fluorine, trifluoromethyl, and combinations thereof wherein at least three of R1, R2, R3, R4, and R5 represent hydrogen and at least three of R1′, R2′, R3′, R4′ and R5′ represent hydrogen;
R1, R2, R3, R4, R5, R1′, R2′, R3′, R4′, and R5′ represent residues selected from hydrogen, methyl, ethyl, n-propyl, isopropyl, fluorine, trifluoromethyl, and combinations thereof wherein either all of R1, R2, R3, R4 and R5 represent hydrogen or all of R1′, R2′, R3′, R4′ and R5′ represent hydrogen.

5. The metal complex according to claim 1, wherein index p is 1 and the complex corresponds to the general formula (I-A) or (I-B), or wherein index p is 2 and the metal complex corresponds to the general formula (I-C) 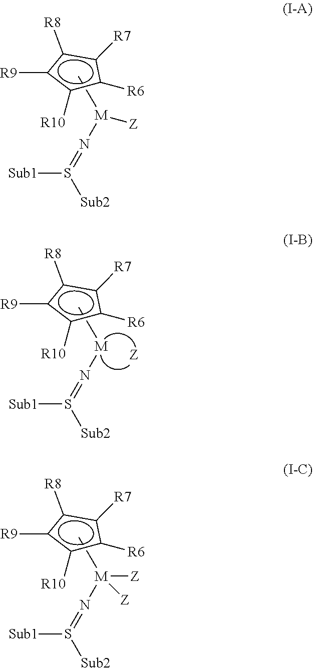
wherein in each case R6, R7, R8, R9 and R10 are selected independently of one another from the group consisting of —H, —CH₃, —CH₂CH₃, —CH₂CH₂CH₃, —CH(CH₃)₂, —C₄H₉, —C₆H₁₃, —C₁₀H₂₁, -phenyl, -biphenyl, and —Si(CH₃)₃.

6. The metal complex according to claim 1, wherein index p is 1 and the complex has general formula (I-D), or wherein index p is 2 and the complex has general formula (I-E) 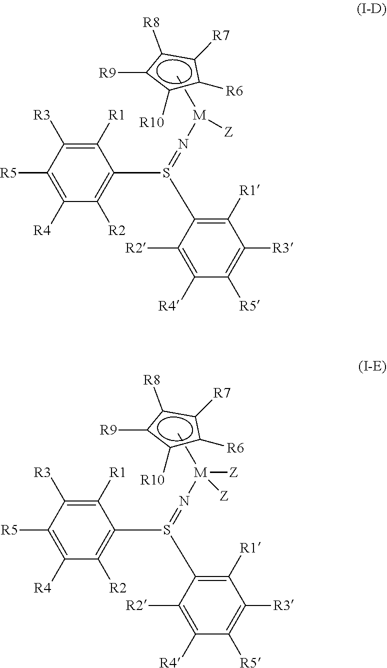
wherein in each case
the ligand Z is selected from the group consisting of —CH₃, -benzyl, —Si(CH₃)₃, —CH₂—Si(CH₃)₃, -phenyl, —O-phenyl, -phenyl, and —O-phenyl substituted with 1, 2, 3, 4 or 5 substituents selected independently of one another from the group consisting of —O—C₁₋₁₂-alkyl, —N(C₁₋₁₂-alkyl)₂, F, Cl, and —Si(C₁₋₁₂-alkyl)₃;
R1, R2, R3, R4, R5, R1′, R2′, R3′, R4′, and R5′ are selected independently of another from the group consisting of H, F, Cl, Br, I, —C₁₋₁₂-alkyl, —C₁₋₁₂-fluoroalkyl, —Si(C₁₋₁₂-alkyl)₃, -phenyl, —NH₂, —NH(C₁₋₁₂-alkyl), —N(C₁₋₁₂-alkyl)₂, —C(═O)—NH₂, —C(═O)—NH(C₁₋₁₂-alkyl), —C(═O)—N(C₁₋₁₂-alkyl)₂, —OH, —O—C₁₋₁₂-alkyl, —O—C₁₋₁₂-fluoroalkyl, —S—C₁₋₁₂-alkyl, and —C(═O)C₁₋₁₂-alkyl;
R6, R7, R8, R9 and R10 are selected independently of one another from the group consisting of —H, —CH₃, —CH₂CH₃, —CH₂CH₂CH₃, —CH(CH₃)₂, —C₄H₉, —C₆H₁₃, —C₁₀H₂₁, -phenyl, -biphenyl, and —Si(CH₃)₃.

7. The metal complex according to claim 1, wherein the index p is 2 and the metal complex corresponds to the general formula (I-E) 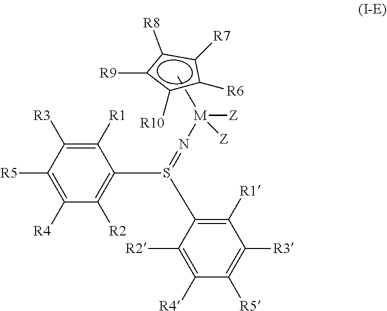
wherein each Z is selected independently from each other from the group consisting of —CH₃, -benzyl, —Si(CH₃)₃, —CH₂—Si(CH₃)₃, -phenyl, —O-phenyl, -phenyl, and —O-phenyl substituted with 1, 2, 3, 4 or 5 substituents selected independently of one another from the group consisting of —O—C₁₋₁₂-alkyl, —N(C₁₋₁₂-alkyl)₂, —F, —Cl, and —Si(C₁₋₁₂-alkyl)₃;
R1, R2, R3, R4, R5, R1′, R2′, R3′, R4′, and R5′ are selected independently of another from the group consisting of H, F, Cl, Br, I, —C₁₋₁₂-alkyl, —C₁₋₁₂-fluoroalkyl, —Si(C₁₋₁₂-alkyl)₃, -phenyl, —NH₂, —NH(C₁₋₁₂-alkyl), —N(C₁₋₁₂-alkyl)₂, —C(═O)—NH₂, —C(═O)—NH(C₁₋₁₂-alkyl), —C(═O)—N(C₁₋₁₂-alkyl)₂, —OH, —O—C₁₋₁₂-alkyl, —O—C₁₋₁₂-fluoroalkyl, —S—C₁₋₁₂-alkyl and —C(═O)C₁₋₁₂-alkyl,
wherein R6, R7, R8, R9 and R10 are selected independently of one another from —H and —CH₃.

8. The metal complex according to claim 1, wherein wherein the index p is 2 and the metal complex corresponds to the general formula (I-E) 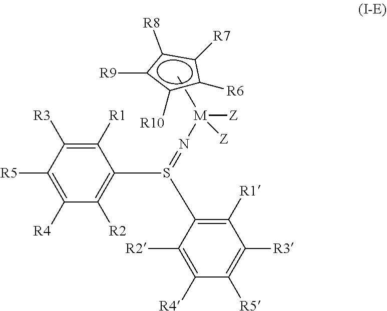
wherein each Z is selected independently from each other from the group consisting of —CH₃, -benzyl, —Si(CH₃)₃, —CH₂—Si(CH₃)₃, -phenyl, —O-phenyl, -phenyl, and —O-phenyl substituted with 1, 2, 3, 4 or 5 substituents selected independently of one another from the group consisting of —O—C₁₋₁₂-alkyl, —N(C₁₋₁₂-alkyl)₂, —F, —Cl, and —Si(C₁₋₁₂-alkyl)₃;
R6, R7, R8, R9 and R10 are selected independently of one another from —H and —CH₃, wherein R1, R2, R3, R4, R5, R1′, R2′, R3′, R4′, and R5′ are selected independently of another from —H, —F, —Cl, —Br, —I, —CF₃, —CH₃, —CH₂CH₃, —CH₂CH₂CH₃, —CH(CH₃)₂, —C₄H₉, —C₆H₁₃, —C₁₀H₂₁; phenyl, and —Si(CH₃)₃ and wherein at least 2 or at least 3 of R1, R2, R3, R4, R5, R1′, R2′, R3′, R4′ and R5′ are selected from —H.

9. The metal complex according to claim 1, wherein the index p is 2 and the metal complex corresponds to the general formula (I-E) 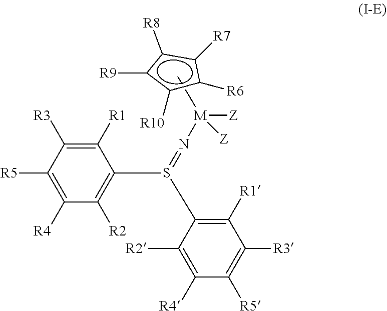
wherein each Z is selected independently from each other from the group consisting of 13 CH₃, -benzyl, —Si(CH₃)₃, —CH₂—Si(CH₃)₃, -phenyl, —O-phenyl, -phenyl, and —O-phenyl substituted with 1, 2, 3, 4 or 5 substituents selected independently of one another from the group consisting of —O—C₁₋₁₂-alkyl, —N(C₁₋₁₂-alkyl)₂, —F, —Cl, and —Si(C₁₋₁₂-alkyl)₃;
R6, R7, R8, R9 and R10 are selected independently of one another from —H and —CH₃, wherein
R1, R2, R3, R4, R5, R1′, R2′, R3′, R4′, and R5′ represent residues selected from hydrogen, methyl, ethyl, n-propyl, isopropyl, fluorine, trifluoromethyl, and combinations thereof wherein at least two of R1, R2, R3, R4 and R5 represent a hydrogen and at least two of R1′, R2′, R3′, R4′ and R5′ represent a hydrogen;
R1, R2, R3, R4, R5, R1′, R2′, R3′, R4′, and R5′ represent a residue selected from hydrogen, methyl, ethyl, n-propyl, isopropyl, fluorine, trifluoromethyl, and combinations thereof wherein at least three of R1, R2, R3, R4, and R5 represent H and at least three of R1′, R2′, R3′, R4′ and R5′ represent hydrogen;
R1, R2, R3, R4, R5, R1′, R2′, R3′, R4′, and R5′ represent hydrogen, methyl, ethyl, n-propyl, isopropyl, fluorine, trifluoromethyl, and combinations thereof wherein either all of R1, R2, R3, R4 and R5 represent hydrogen or all of R1′, R2′, R3′, R4′ and R5′ represent hydrogen.

10. The metal complex according to claim 1 wherein the metal M is titanium.

11. The metal complex according to claim 1 wherein Z is —CH₃.

12. A process for preparing a polymer wherein the process comprises the steps
(a) providing a monomer composition comprising ethylene;
(b) contacting at least a fraction of the monomer composition with a catalyst composition comprising at least one metal complex according to claim 1 to produce a polymer wherein the polymer comprises units derived from ethylene.

13. The process of claim 12, wherein the polymer is an ethylene/alpha-olefin copolymer having units derived from ethylene and from at least one alpha-olefin having from 3 to 20 carbon atoms, and, optionally, from at least one non-conjugated diene having from 6 to 30 carbon atoms and having at least one cyclic unit, and wherein the monomer composition comprises ethylene, propylene and optionally at least one alpha-olefins having from 3 to 20 carbon atoms and, optionally, at least one non-conjugated diene having from 6 to 30 carbon atoms and having at least one cyclic unit and wherein, optionally, the copolymer has a weight average molecular weight of at least 200,000 g/mole as determined by gel permeation chromatography.

14. The process of a claim 12, wherein the polymer is an ethylene/propylene/diene copolymer containing units derived from dienes selected from 5-ethylidene-2-norbornene (ENB), 5-vinyl-2-norbornene (VNB), dicyclopentadiene (DCPD), and a combination thereof.

15. (canceled)

16. The process of claim 13, wherein the polymer is an ethylene/propylene/diene copolymer containing units derived from dienes selected from 5-ethylidene-2-norbornene (ENB), 5-vinyl-2-norbornene (VNB), dicyclopentadiene (DCPD) and a combination thereof.
